(19) United States
(12) Patent Application Publication
(10) Pub. No.: US 2010/0311017 A1
(43) Pub. Date: Dec. 9, 2010

(54) MODULAR MONITORING SYSTEM

(75) Inventors: Jeff COIL, Hiawatha, IA (US); Jamie SCHERKENBACH, Hiawatha, IA (US)

Correspondence Address: SUGHRUE MION, PLLC, 2100 PENNSYLVANIA AVENUE, N.W., SUITE 800, WASHINGTON, DC, 20037, US

(73) Assignee: Trapeze Software Inc., Mississauga (CA)

(21) Appl. No.: 12/479,345

(22) Filed: Jun. 5, 2009

(51) Int. Cl. G09B 9/04; G06F 19/00

(52) U.S. Cl. 434/65; 701/29; 701/35; 701/33

(57) ABSTRACT

The present invention relates to a modular monitoring system for a mobile vehicle, comprising: a) a core unit for controlling, receiving and integrating hardware modules and software modules; b) one or more hardware modules, each hardware module responsible for monitoring one or more operating parameters of said mobile vehicle; and c) one or more software modules, each software module responsible for monitoring one or more operating parameters of said mobile vehicles.

### FIELD OF THE INVENTION

The present invention relates to the field of vehicle system monitoring. In particular, it relates to a monitoring system which is capable of monitoring different status conditions on a vehicle that is customizable through the insertion or removal of modules.

### BACKGROUND OF THE INVENTION

For operators of vehicles fleets, particularly passenger vehicles such as transit buses and the like, it is important to be able to monitor the status of various conditions, both internal and external, of the vehicles as often as possible.

One set of conditions includes the internal operating conditions of the vehicle. Basic monitoring of operating parameters such as speed, oil pressure, fuel capacity, etc. are standard equipment on almost all vehicles, however, their effectiveness can be increased by complementing the active monitoring with record storage so that long-term effects can be tracked.

Other conditions are external to vehicle operating conditions. These include conditions such as weather, time of day, location, passenger load, etc. These conditions also affect the overall performance of the vehicle, but are subject to less or no control from the vehicle operator. Again, a combination of active monitoring of these conditions with record storage for tracking long-term effects can be used to improve the overall performance of a vehicle, or vehicles in the case of operating a vehicle fleet, such as a group of transit buses.

Furthermore, organizations, such as transit providers, may use a variety of vehicle types as part of their operations. There is a need for a monitoring system that can be uniformly used across vehicle types with a minimal amount of modification. Ideally, such a system would furthermore be transferable between different types of vehicles.

Another issue for transit operators is driver performance. Vehicle parameters can be monitored that reflect the performance of the driver of the vehicle, in addition to the vehicle itself. Fuel consumption, for example, is affected not only by the condition of the vehicle, but also by the performance and style of the driver. Thus, there is a need for a monitoring system that enables measurement of driver performance in addition to vehicle performance.

In general, there is a need for an improved system of monitoring operating conditions within vehicles. Additionally, any such system should ideally provide for incorporation of data from the monitoring system into assessments of driver performance.

It is an object of this invention to partially or completely address one or more of the above-mentioned needs.

### SUMMARY OF THE INVENTION

According to an aspect of the present invention, there is provided a modular monitoring system for a mobile vehicle, comprising: a) a core unit for controlling, receiving and integrating hardware modules and software modules; b) one or more hardware modules, each hardware module responsible for monitoring one or more operating parameters of said mobile vehicle; and, c) one or more software modules, each software module responsible for monitoring one or more operating parameters of said mobile vehicles.

Preferably, the system has each hardware module associated with one or more software modules. Alternatively, each software module is associated with one or more hardware modules.

Preferably, the core unit is integrated into a dashboard unit of the vehicle. Alternatively, the core unit is provided as a stand-alone unit within the vehicle.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is representational drawing of a vehicle containing the present inventive modular system;

FIG. 2 is a block diagram of the modular system according to an embodiment of the present invention;

FIG. 3 is a block diagram of a modular system implement on a transit bus according to an embodiment of the present invention.

### DETAILED DESCRIPTION OF THE INVENTION

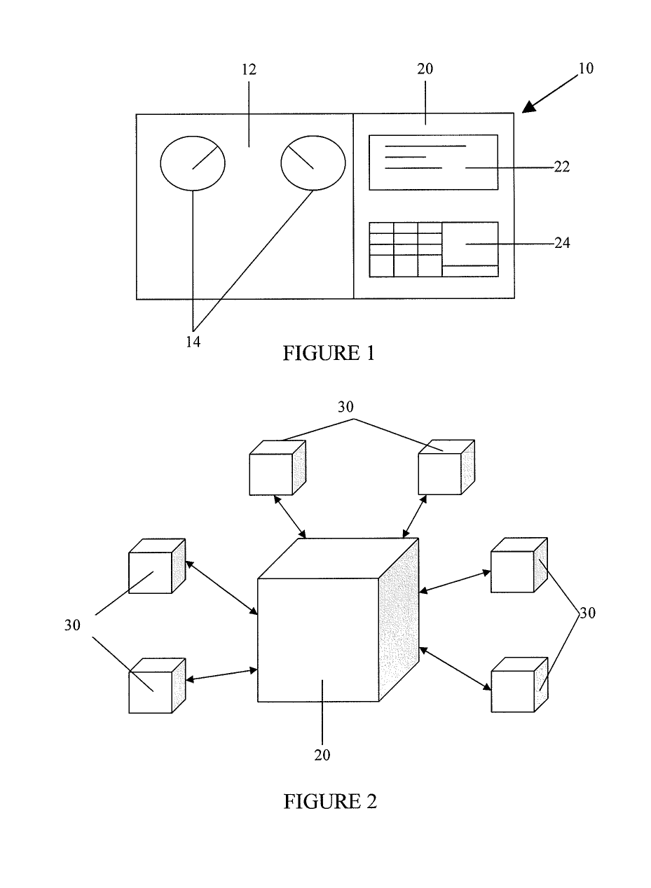

In accordance with FIG. 1, a vehicle, such as a bus, includes as part of its dashboard 10 (or similar driver/operator position), in addition to the standard vehicle display 12 with gauges 14 such as a speedometer and a fuel gauge, a monitoring system 20 for monitoring both internal and external operating conditions for the vehicles. Internal operating conditions are primarily those related to the actual mechanical operation of the vehicle, such as fuel consumption, engine RPM, oil pressure, vehicle speed, etc. External operating conditions are those which are not directly related to the mechanical operation of the vehicle, but that can still affect performance, such as weather, passenger load, time of day, etc.

Not all vehicles require the same degree of monitoring. Furthermore, it may be desirable to monitoring certain conditions over a fixed period of time. For example, passenger load may be monitored for a month to establish operating conditions and then no longer monitored. For this reason, it is desirable to have a monitoring system that can be readily and easily modified to meet the needs of a particular vehicle.

The inventive system and method presented herein fulfills that desire by creating a modular monitoring system. That is, a monitoring system which is based on removable and interchangeable hardware and software modules. The modular monitoring system permits the same system to be installed on multiple vehicles and suitably modified for individual vehicles with minimal time and expense requirements.

The system, as shown in FIG. 2, consists of a core unit 20, which fulfills the purposes of monitoring various conditions through attached and integrated hardware and software modules 30. The core unit 20 is mounted on the vehicle and has a display 22 and/or is integrated into existing displays on the dashboard of the vehicle 10. Preferably, the core unit 20 also has an input device 24, such as a keyboard or keypad, to allow for control of the core unit 20 and the modules connected to the core unit 20. The core unit 20 itself may be integrated into the dashboard 10 as shown in FIG. 1 or provided as a separate unit. In certain vehicle configurations, the core unit 20 may further be located at a separate location from the driver's position, if monitoring of the information by the driver is not required. Preferably, the core unit 20 is a computer server.

The modules 30 connected to the core unit 20 can be mounted within or as part of the core unit 20, or may be separately mounted, preferably removably, elsewhere in the vehicle 10, particularly in the case of hardware modules.

Modules preferably mounted within the core unit 20 include interface modules, such as the display 22, a keyboard 24 or other user interface, power indicators, storage and memory (hard drive, flash-based, etc.), real-time clock, etc.

Modules preferably connected to the core unit 20, but which may be mounted within the core unit 20 can include standard vehicle monitoring systems, such as fuel gauges, temperature gauges, tachometers, speedometers, odometers, etc.

Other modules 30 which are mounted in separate locations throughout the vehicle include such monitors as passenger seat sensors, surveillance cameras, communications systems, GPS systems, etc. Preferably, these modules 30 should be removably mounted to enable transfer between vehicles or removal and replacement of obsolete or unnecessary modules.

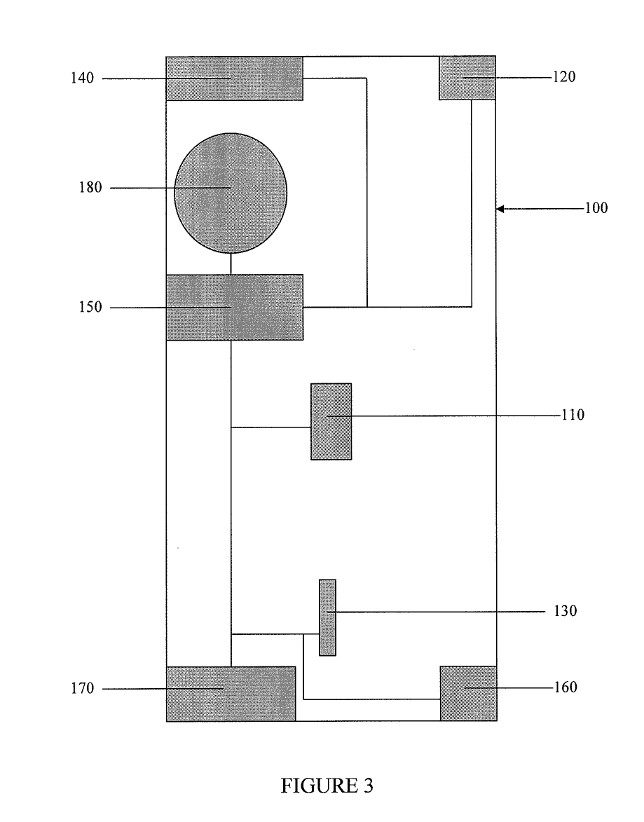

For example, as shown in the block diagram of FIG. 3, a standard set of modules for monitoring driver performance on a transit bus 100 can include a acceleration, shock and vibration sensor 110, a GPS locator 120, a fuel consumption monitor 130, and a video camera 140. Additional modules can be provided for data storage, such as a server 150 and data transmission, either wired or wireless, such as antenna 160. As shown, the driver position 180 is at the front of the vehicle, with video camera 140 also monitoring the front of the vehicle, with acceleration sensor 110 mounted near the center of the vehicle and fuel consumption monitor 130 at the back (assuming a rear-engine vehicle). As contemplated herein, the location of all modules can be adjusted to account for difference in vehicle shape, size, and style.

While the above modules are present in terms of hardware, the modularity of the system is readily applied to the software used to control the core unit 20 and modules 30 as well.

Preferably, each hardware module has an associated software module than can be integrated into the overall software package to allow for use of the hardware module. Alternatively, a software module can be used to control multiple hardware modules, preferably related hardware modules. Also, there may be software modules (e.g. computational modules) that can be used without hardware.

For example, with the hardware modules discussed above for monitoring driver performance, each module requires control software, as well as a storage system for data recorded by the modules. While all modules can use the same storage system, it is generally preferable to provide video module 140 with its own storage system for increased access speed and to provide as much storage space as is possible. Additionally, a software module is needed to connect the separate modules, so that collected data can be time-marked and location-marked (via the GPS locator 120) for later analysis. Preferably, a server 150 is provided as the core unit for the system, housing all the software modules and the data storage system. Thus, the core unit is readily transferred with the hardware and software modules, greatly facilitating implementation on any vehicle. As can be seen in FIG. 3, each module is then connected to the server 150 for operational control, data recording and data transmission. Further modularity of the system can be achieved by implementing hardware modules into the core unit server 150, if applicable, such as acceleration sensor 110 and GPS locator 120.

In addition to replacement and upgrades, as discussed above, the modular system further allows for advances in technology and other changes to vehicle requirements to be addressed in a modular fashion. Devices or procedures that were previously not contemplated can be readily implemented and integrated merely by the creation of a suitable module, although the requirements and specifications of creating such a module is not itself contemplated herein. For example, a second video system 170 can be added to monitor the rear and/or side of the vehicle, or system monitoring and programming controls at the driver's position 180.

One example is with the provision of a training vehicle. It is common, particularly in bus fleets, to have one or more vehicles which are dedicated to training new drivers. These training vehicles are generally equipped with extra hardware and software for providing and monitoring training exercises. Typical equipment includes internal and external cameras, engine performance monitoring and recording, and even traffic/passenger simulation equipment. Such training vehicles are substantially more expensive than a standard vehicle and, as such, tend not to be used other than for training purposes. As a result, the vehicle remains unused when there is no ongoing training.

The modular system resolves this problem by allowing any vehicle to be converted into a training vehicle by the addition of the proper hardware and software modules. Thus, savings are realized as there is no need to provide for a dedicated training vehicle or vehicles. Also, the training ‘fleet’ can be easy expanded by acquiring additional modules, which are again, substantially less expensive than purchasing an entire training vehicle. There is also no downtime, as the vehicle can be readily restored to normal use by merely removing the modules, or even disabling them, if that does not interfere with normal vehicle performance. There is also the potential to develop alternative and potentially superior training methods by being able to convert standard vehicles and routes for training purposes.

This application of the system can also be used in a similar fashion for monitoring of driver performance, either for review or disciplinary purposes. Again, the ability to temporarily install the necessary modules for monitoring allows for it to take place with reduced disruption and expense.

As an example, take a transit bus. By installing the modules described above in FIG. 3, the driver's route can be tracked, along with the collected data from the sensors and monitors, and this information further linked to the recorded video and GPS coordinates. The server 150 controls all the modules and provides data storage. The data is thus stored onboard the bus, and retrieved (via wired or wireless connection) at the end of the day when the vehicle returns to dock. Alternatively, or additionally, as required, the vehicle can further include a real-time wireless module to stream the data wirelessly from the server during the course of the day's operations, either continuously or at pre-determined intervals (e.g. at bus stops).

The collected data can then be subsequently reviewed with the collected video and GPS information to determine if the vehicle performance was within acceptable parameters for the conditions, and if there were any irregularities to account for deviations from the parameters. For example, a recorded data section indicating excessive application of braking force can be accounted for by concurrent video records of a pedestrian unexpectedly entering the path of the vehicle. Similarly, unusual fuel consumption data can reflect unusual external conditions, such as inclement weather.

In addition to the performance analysis benefits of the collected data, the data can also be implemented as part of driver training and/or re-training. By displaying the vehicle performance data alongside the recorded video data, drivers can be shown problem areas in a route prior to actually driving the route. With advance knowledge of the performance characteristics of a route, the learning curve for a driver is flattened and required performance levels are reached sooner.

Similarly, the data can be applied to driver review and re-training. By reviewing an existing driver's performance on a route, areas of improvement can be more readily identified for the driver to work on. Furthermore, comparisons can be made against past data to determine if improvement performance is being seen. Also, as the modular system enable multiple vehicles on multiple routes to be equipped for data recording, it is also possible to compare the same driver's performance on different route, to assess whether any potential performance issues are route-specific or driver-specific. For example, data indicating excessive braking by a driver on a single route could indicate that the driver needs to improve performance on that route (e.g. better recognition of approaching inclines and declines). However, if the data shows excessive braking by the same driver on all their routes, the issue is now more clearly identified as part of the driver's overall performance, and a need for more comprehensive retraining to improve performance on all their routes.

Also, comparisons can be made between different drivers on the same route, with the ‘best’ driver setting a non-theoretical optimum performance level for all drivers covering that route. A direct comparison against real performance data can be used to provide rewards and motivation to drivers to improve their performance towards a result that is recognized as achievable, as opposed to theoretical performance marks, which can be consider as less tangible.

By implementing the inventive modular monitoring system, rather than allocate an expensive customized vehicle for data collection purposes, any existing vehicle can be readily and rapidly set up as a data collection platform. Additionally, by adding modules to existing vehicles, any potential bias resulting from drivers handling an unfamiliar customized vehicle, rather than their existing standard vehicle, is minimized. By making the monitoring as unobtrusive as possible, the collected data is likely to be more representative of the driver's standard performance, rather than reflecting an adjustment (positive or negative) in response to the driver's awareness of the monitoring.

Another benefit is that archived video and GPS data can be recalled to provide a future reference in the event that any irregular incidents involving the vehicle, driver, or route later arise. The archived data can be of particular use in incidents involving vehicle collisions, for example.

As another example, the modular system can be used to create a greater degree of uniformity among disparate vehicle types. In a transit system, there may be several vehicle types, such as buses, trains, subways, mini-buses and vans. By providing the core unit on each vehicle, along with specialized modules pertaining to the individual vehicle types, a cohesive integrated data structure is created and more easily maintained. This also allows for redistribution and redeployment of different vehicles types more rapidly without a loss of uniformity and control.

The modularity of the system also allows for vehicle rotation without the need for retrofitting or other modifications that would interfere with data tracking. For example, route monitoring can determine that some routes produce greater wear on vehicle than others. A solution to that issue is to rotate vehicles through routes to equalize wear. However, vehicle rotation would previously be made difficult by the need to re-implement the monitoring equipment for a given route on a new vehicle. The modular system reduces the work and effort involved and allows for more efficient vehicle rotation. Additionally, efficient vehicle rotation enables the same route to be monitored from different vehicles, which can expose weakness in particular vehicles (i.e. excessive fuel consumption or excess vibration) that can be flagged and addressed as maintenance issues.

The above description does not contemplate any requirements for a specific structure, assembly or programming of any hardware or software modules.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1. A modular monitoring system for a mobile vehicle, comprising:
a) a core unit for controlling, receiving and integrating hardware modules and software modules;
b) one or more hardware modules, each hardware module responsible for monitoring one or more operating parameters of said mobile vehicle; and
c) one or more software modules, each software module responsible for monitoring one or more operating parameters of said mobile vehicles.

2. The system of claim 1, wherein said hardware modules include a video recording module, a fuel consumption monitoring module, an acceleration/vibration measurement module, a GPS locator module and at least one data storage module.

3. The system of claim 2, further including multiple data storage modules, with one of said multiple data storage modules allocated to said video recording module.

4. The system of claim 2, further including a data transmission module, which enables data from any hardware module to be sent to a database remote from said mobile vehicle.

5. The system of claim 4, wherein said data transmission module is a wireless data transmission module.

6. The system of claim 5, wherein said wireless data transmission module operates in real time during operation of said mobile vehicle.

7. The system of claim 1, wherein each hardware module is associated with one or more software modules.

8. The system of claim 1, wherein each software module is associated with one or more hardware modules.

9. The system of claim 1, wherein said core unit is integrated into a dashboard unit of said vehicle.

10. The system of claim 1, wherein said core unit is provided as a stand-alone unit within said vehicle.

11. The system of claim 1, wherein said hardware modules and said software modules are individually and separately removable.

12. The system of claim 1, wherein said hardware modules and said software modules are individually and separately upgradeable.

13. The system of claim 1, wherein said core unit is a computer server incorporating all of the software modules.

14. The system of claim 13, wherein the server further incorporates at least one hardware data storage module.

15. A method of monitoring and recording operational data for a mobile vehicle, comprising:
a) installing one or more hardware modules on said mobile vehicle, each said hardware module operative to collect one or more elements of said operational data;
b) installing one or more software modules on said mobile vehicle, each said software module operative to control one or more of said hardware modules;
c) recording the collected operational data for subsequent analysis.

16. The method of claim 15, wherein said recording step is performed onboard said vehicle.

17. The method of claim 16, further including a step of transmitting said recorded data to a database remote from said vehicle.

18. The method of claim 17, wherein said transmitting step is performed in real time during operation of said vehicle.

19. The method of claim 15, further including a step of displaying the collected operational data to a vehicle driver during operation of the vehicle.

20. A method of training a driver of a vehicle, comprising:
a) installing a set of hardware and software modules, including a video recording module, a fuel consumption monitoring module, an acceleration/vibration measurement module, a GPS locator module and at least one data storage module on the driver's vehicle;
b) collecting data from the hardware and software modules for a route and a vehicle assigned to the driver; and
c) reviewing the collected data with the driver and assigning training to the driver based on the review.

21. The method of claim 20, wherein the driver is a transit driver and the driver's vehicle is a transit vehicle.

22. The method of claim 21, further including a step of comparing the collected data with comparison data collected from other drivers and adding the comparison data to the reviewing step.

23. The method of claim 22, wherein the collected data for the other drivers is collected on the same vehicle as used in the collecting step for the driver.

24. The method of claim 22, wherein the collected data for the other drivers is collected on the same route as used in the collecting step for the driver.
